(19) United States
(12) Patent Application Publication
(10) Pub. No.: US 2019/0260853 A1
(43) Pub. Date: Aug. 22, 2019

(54) SYSTEMS AND METHODS FOR ENERGY EFFICIENT REMOTE ACCESS PROTOCOL

(71) Applicant: Citrix Systems, Inc., Fort Lauderdale, FL (US)

(72) Inventors: Revathi Ayyadurai, Bangalore (IN); Santosh Sampath, Bangalore (IN)

(21) Appl. No.: 15/900,492

(22) Filed: Feb. 20, 2018

(51) Int. Cl. H04L 29/06; H04L 29/08

(52) U.S. Cl. CPC H04L 67/42; H04L 67/303; H04L 67/141

(57) ABSTRACT

Systems and methods for energy aware transmission of data to a client device in a cloud environment during a remote session. The method includes, by a processor: establishing a remote session between the client device and a server, receiving a battery status corresponding to the client device, determining a battery profile associated with the received battery status for the client device, accessing a rule set to determine if there is at least one action associated with the battery profile. The at least one action corresponds to transmission of data from the server to the client device. The method further includes executing the at least one action if there is at least one action associated with the battery profile.

### BACKGROUND

### Statement of the Technical Field

The present disclosure relates generally to cloud computing systems. More particularly, the present invention relates to implementing systems and methods for energy efficient transmission of data to a client device in a remote access protocol.

### Description of the Related Art

In recent years, cloud computing systems and methods have been employed for the provisioning of dynamically scalable and often virtualized computing resources that can be allocated as a service over a data communication network, such as the Internet, and the like. Such cloud computing systems and methods can be configured for Software as a Service (SaaS), Platform as a Service (PaaS), Infrastructure as a Service (IaaS), and the like, services, which can fall under the umbrella of cloud computing. Cloud computing offers an on-demand model for computing that reduces, or in some cases, completely avoids the hardware and software maintenance costs for an end user of the computing services.

The proliferation of mobile devices—including smart phones, laptops, and tablets—presents new challenges for cloud computing. These devices have limited power and tend to consume battery reserves at an increased rate while maintaining connectivity with a cloud server (for example, cellular, Bluetooth, and/or WiFi). Also, a server application requiring significant data transfer (e.g., a video) may consume considerable amounts of processing resources due to the load it places on the connection and the mobile device processor, also resulting in reduced battery life. As such, energy consumption in a mobile device may be a function of many factors including amount of data or resolution of data transmitted, frequency of data transmission, and distance of the mobile device from a remote server. Additionally, mobile devices are utilizing more and more complex functionality and such increases in processing may also increase power consumption, which can adversely affect the user experience in power limited situations such as when a battery is the power source for the device. One example use case where mobile devices have seen a large increase in Internet traffic is in mobile video content generation and delivery. As mobile devices are configured to perform more processing intense methods for video streaming and/or decoding, there may be tradeoffs in terms of power usage.

Some mobile device manufacturers recommend disabling wireless communication on the device to conserve battery life when wireless communication is unneeded, because the power consumed on a mobile device may increase several-fold when the wireless communication is in use, versus a much lower consumption rate when the device is not actively transmitting and/or receiving data. Similarly, when a device has the Wi-Fi communication enabled, but is in a suspended state (that is, not sending and/or receiving data), the device may draw hundreds of times less current than an active transmission/reception phase.

However, such device-level applications for extending the battery life of a mobile device may not be useful in a cloud computing system (i.e., a client-server scenario) because the server side is typically unaware of the power attributes (e.g., remaining battery life) of the client device with which it is communicating. As such, a server may continue to transmit data at the fastest possible rate accepted by the mobile device and/or allowed by a transmission protocol, regardless of battery status of the mobile device. Accordingly, battery charge may be quickly depleted while accommodating unnecessarily high data transmission rates. From the client side, it may be inconvenient or unfeasible to manually monitor and configure communication settings associated with the transmission requirements of one or more applications executing in a cloud computing system.

### SUMMARY

Implementing systems and methods for energy aware transmission of data to a client device in a cloud environment. The method may include, by a processor: establishing a remote session between the client device and a server, receiving a battery status corresponding to the client device, determining a battery profile associated with the received battery status for the client device, accessing a rule set to determine if there is at least one action associated with the battery profile. The at least one action corresponds to transmission of data from the server to the client device. The method further includes executing the at least one action if there is at least one action associated with the battery profile.

In some scenarios, receiving the battery status corresponding to the client device may include receiving one or more of the following: battery power level of one or more batteries of the client device, or an indication corresponding to whether or not the client device is connected to an external power source.

In at least one scenario, determining the battery profile associated with the received battery status may include determining a rate of power consumption by the client device, wherein the rate of power consumption is attributable to the remote session. In a scenario, determining the battery profile associated with the received battery status may also include determining a time remaining until total discharge of client device power reserves based on the rate of power consumption and the battery status. Optionally, determining the rate of power consumption may include monitoring one or more characteristics of one or more active applications corresponding to the remote session. The one or more characteristics may be selected from the following: network connection bandwidth, network connection type, radio signal strength required for executing an application, processing power requirement for am application, user requested quality level, size of data being transmitted from the server to the client, data transmission rate, processing costs, or refresh rates associated an output screen.

In certain scenarios, the at least one action may be disabling one or more high bandwidth consumption virtual channels, adjusting the number of frames transmitted per second, selecting audio and/or video codec types that require less power for transmission and rendering on the client device, adjusting the image quality to optimize data processing at the client device while maximizing the battery life, providing prompts to a user of the client device to select applications whose execution consumes less power, transmitting and rendering only certain regions of a desktop on the client device, and/or caching stable regions of a desktop locally to avoid transmission and rendering of such regions.

In one or more scenarios, receiving the battery status corresponding to the client device may include receiving the battery status from an operating system of the client device, a redirected virtual battery, and/or from a client agent corresponding to the remote session. Optionally, receiving the battery status corresponding to the client device may include receiving the battery status continuously, periodically, and/or upon occurrence of a triggering event. The triggering event may include one or more of the following: a threshold battery charge percentage, a threshold rate of power consumption, or a threshold time to complete discharge of a battery.

In some scenarios, the rule set may include one or more look up tables, and each look up table may associate each of a plurality of battery profiles with one or more actions corresponding to transmission of data from the server to the client device.

In at least one scenario, the method may also include prompting a user to confirm execution of the at least one action.

### BRIEF DESCRIPTION OF THE DRAWINGS

Embodiments will be described with reference to the following drawing figures, in which like numerals represent like items throughout the figures.

FIG. 1 is an illustration of an exemplary cloud computing environment, according to an embodiment.

FIG. 2 is an illustration of an exemplary computing device, according to an embodiment.

FIG. 3 is an illustration of an exemplary system that may be used to implement the methods disclosed herein.

FIG. 4 is a block diagram of an embodiment of a client device for communicating with a server, according to an embodiment.

FIG. 5 is a flowchart illustrating an example method for energy efficient transmission of data in a remote access protocol in a cloud computing environment.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

The term “mobile device,” as used herein, refers to a portable computing device that includes a battery power source, a processor and non-transitory, computer-readable memory. The memory may contain programming instructions in the form of a software application that, when executed by the processor, causes the device to perform battery monitoring and/or energy conservation related operations according to the programming instructions. Examples of suitable devices include portable electronic devices such as smartphones, personal digital assistants, cameras, tablet devices, electronic readers, personal computers, media players, satellite navigation devices and the like.

The term “remote session”, as used herein, refers to a session hosted on a network-accessible computer system (e.g., a server) to which an end-user's computer system (e.g., client device) is connected. In other words, a client device may establish a remote session with a server to provide to a user of the client device access to resource and/or applications on the server.

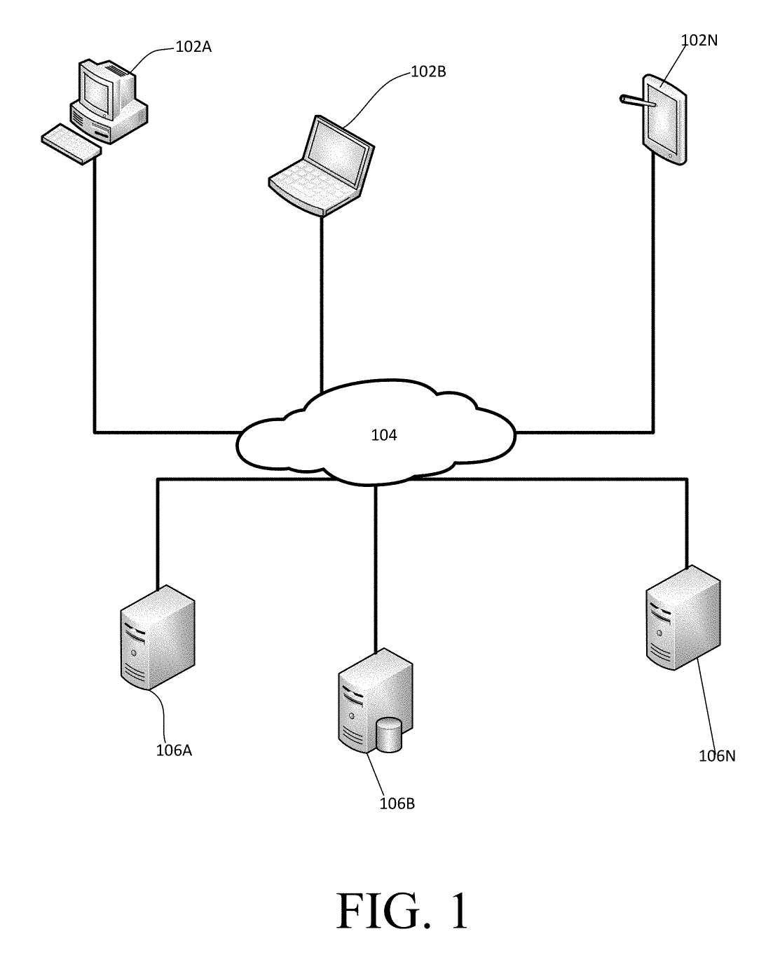

Referring now to FIG. 1, a schematic block diagram illustrating an example cloud computing environment in which the embodiments described herein may be implemented is shown. FIG. 1 illustrates one embodiment of a cloud computing environment 101 that includes one or more client machines 102A-102N (generally referred to herein as “client machine(s) 102A-N”) in communication with one or more servers 106A-106N (generally referred to herein as “server(s) 106A-N”). Installed in between the client machine(s) 102A-N and server(s) 106A-N is a network 104. One or more of the client devices 102A-N may be battery powered mobile devices.

In one embodiment, the computing environment 101 can include an appliance installed between the server(s) 106A-N and client machine(s) 102A-N (not shown here). This appliance may manage client/server connections, and in some cases can load balance client connections amongst a plurality of backend servers. For example, the appliance may be a cloud management server and/or a cloud connector that may provide a communication link between the client machine(s) 102A-N and the server(s) 106A-N for accessing computing resources (cloud hardware and software resources) hosted by the server(s) 106A-N in a cloud-based environment. The cloud hardware and software resources may include private and/or public components. For example, a cloud may be configured as a private cloud to be used by one or more particular customers or client computers and/or over a private network. In other embodiments, public clouds or public-private clouds may be used by other customers over open or closed networks.

The client machine(s) 102A-N can in some embodiment be referred to as a single client machine or a single group of client machines, while server(s) 106A-N may be referred to as a single server or a single group of servers. In one embodiment, a single client machine communicates with more than one server, while in another embodiment a single server communicates with more than one client machine. In yet another embodiment, a single client machine communicates with a single server.

Client machine(s) 102A-N can, in some embodiments, be referenced by any one of the following terms: client machine(s); client(s); client computer(s); client device(s); client computing device(s); local machine; remote machine; client node(s); endpoint(s); endpoint node(s); or a second machine. The server(s) 106A-N, in some embodiments, may be referenced by any one of the following terms: server(s), local machine; remote machine; server farm(s), host computing device(s), or a first machine(s).

In one embodiment, one or more of the client machine(s) 102A-N can be a virtual machine. The virtual machine can be any virtual machine, while in some embodiments the virtual machine can be any virtual machine managed by a hypervisor developed by Citrix Systems, IBM, VMware, or any other hypervisor. In other embodiments, the virtual machine can be managed by any hypervisor, while in still other embodiments, the virtual machine can be managed by a hypervisor executing on a server or a hypervisor executing on a client machine.

The client machine(s) 102A-N can in some embodiments execute, operate or otherwise provide an application that can be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions. Still other embodiments include one or more client machine(s) 102A-N that display application output generated by an application remotely executing on a server(s) 106A-N or other remotely located machine. In these embodiments, the client machine(s) 102A-N can display the application output in an application window, a browser, or other output window. In one embodiment, the application is a desktop, while in other embodiments the application is an application that generates a desktop.

The server(s) 106A-N, in some embodiments, execute a remote presentation client or other client or program that uses a thin-client or remote access protocol to capture display output generated by an application executing on a server and transmit the application display output to a remote client machine(s) 102A-N (i.e., establish a remote session). The thin-client or remote access protocol can be any one of the following protocols: the Independent Computing Architecture (ICA) protocol manufactured by Citrix Systems, Inc. of Ft. Lauderdale, Fla.; or the Remote Desktop Protocol (RDP) manufactured by the Microsoft Corporation of Redmond, Wash.

The computing environment 101 can include more than one server(s) 106A-N such that the server(s) 106A-N are logically grouped together into a server farm. The server farm can include servers that are geographically dispersed and logically grouped together in a server farm, or servers that are located proximate to each other and logically grouped together in a server farm. Geographically dispersed servers within a server farm can, in some embodiments, communicate using a WAN, MAN, or LAN, where different geographic regions can be characterized as: different continents; different regions of a continent; different countries; different states; different cities; different campuses; different rooms; or any combination of the preceding geographical locations. In some embodiments the server farm may be administered as a single entity, while in other embodiments the server farm can include multiple server farms.

In some embodiments, a server farm can include server(s) 106A-N that execute a substantially similar type of operating system platform (e.g., WINDOWS, manufactured by Microsoft Corp. of Redmond, Wash., UNIX, LINUX or macOS.) In other embodiments, the server farm can include a first group of servers that execute a first type of operating system platform, and a second group of servers that execute a second type of operating system platform. The server farm, in other embodiments, can include servers that execute different types of operating system platforms.

In some embodiments, computing environment 101 can include more than one server(s) 106A-N such that the server(s) 106A-N are divided into one or more sub-group, each of which is managed and/or operated by a different entity. For example, a first entity may operate and/or manage a first sub-group of server(s) on premise, in a private cloud or in a public cloud, a second entity may operate and/or manage a second sub-group of server(s) on premise, in a private cloud or in a public cloud, a third entity may operate and/or manage a third sub-group of server(s) on premise, in a private cloud or in a public cloud, and so on.

The server(s) 106A-N, in some embodiments, can be any server type. For example, a server can be any of the following server types: a file server; an application server; a web server; a proxy server; an appliance; a network appliance; a gateway; an application gateway; a gateway server; a virtualization server; a deployment server; a SSL VPN server; a firewall; a web server; an application server or as a master application server; a server executing an active directory; or a server executing an application acceleration program that provides firewall functionality, application functionality, or load balancing functionality. In some embodiments, a server may be a RADIUS server that includes a remote authentication dial-in user service. In embodiments where the server comprises an appliance, the server can be an appliance manufactured by any one of the following manufacturers: the Citrix Application Networking Group; Silver Peak Systems, Inc; Riverbed Technology, Inc.; F5 Networks, Inc.; or Juniper Networks, Inc. Some embodiments include a first server 106A that receives requests from one or more client machine(s) 102A-N, forwards the request to a second server 106B, and responds to the request generated by the client machine(s) 102A-N with a response from the second server 106B. The first server 106A can acquire an enumeration of applications available to the client machine(s) 102A-N and well as address information associated with an application server hosting an application identified within the enumeration of applications. The first server 106A can then present a response to the client's request using a web interface, and communicate directly with the client machine(s) 102A-N to provide the client machine(s) 102A-N with access to an identified application.

The server(s) 106A-N can, in some embodiments, execute any one of the following applications: a thin-client application using a thin-client protocol to transmit application display data to a client; a remote display presentation application, or the like. Another embodiment includes a server that is an application server such as: an email server that provides email services such as MICROSOFT EXCHANGE manufactured by the Microsoft Corporation; a web or Internet server; a desktop sharing server; a collaboration server; or any other type of application server. Still other embodiments include a server that executes any one of the following types of hosted servers applications: WEBEX provided by WebEx, Inc. of Santa Clara, Calif.; or Microsoft Office LIVE MEETING provided by Microsoft Corporation.

Client machine(s) 102A-N can, in some embodiments, be a client node that seek access to resources provided by a server. In other embodiments, the server(s) 106A-N may provide client machine(s) 102A-N with access to hosted resources. The server(s) 106A-N, in some embodiments, may function as a master node such that it communicates with one or more client machine(s) 102A-N or server(s) 106A-N. In some embodiments, the master node can identify and provide address information associated with a server hosting a requested application, to one or more clients or servers. In still other embodiments, the master node can be a server farm, a client machine, a cluster of client nodes, or an appliance.

One or more client machine(s) 102A-N and/or one or more server(s) 106A-N can transmit data over a network 104 installed between machines and appliances within the computing environment 101. The network 104 can comprise one or more sub-networks, and can be installed between any combination of the client machine(s) 102A-N, server(s) 106A-N, computing machines and appliances included within the computing environment 101. In some embodiments, the network 104 can be: a local-area network (LAN); a metropolitan area network (MAN); a wide area network (WAN); a primary network comprised of multiple sub-networks located between the client machines 102A-N and the servers 106A-N; a primary public network with a private sub-network; a primary private network with a public sub-network 4; or a primary private network with a private sub-network. Still further embodiments include a network 104 that can be any of the following network types: a point to point network; a broadcast network; a telecommunications network; a data communication network; a computer network; an ATM (Asynchronous Transfer Mode) network; a SONET (Synchronous Optical Network) network; a SDH (Synchronous Digital Hierarchy) network; a wireless network; a wireline network; or a network 104 that includes a wireless link where the wireless link can be an infrared channel or satellite band. The network topology of the network 104 can differ within different embodiments, possible network topologies include: a bus network topology; a star network topology; a ring network topology; a repeater-based network topology; or a tiered-star network topology. Additional embodiments may include a network 104 of mobile telephone networks that use a protocol to communicate among mobile devices, where the protocol can be any one of the following: AMPS; TDMA; CDMA; GSM; GPRS UMTS; or any other protocol able to transmit data among mobile devices.

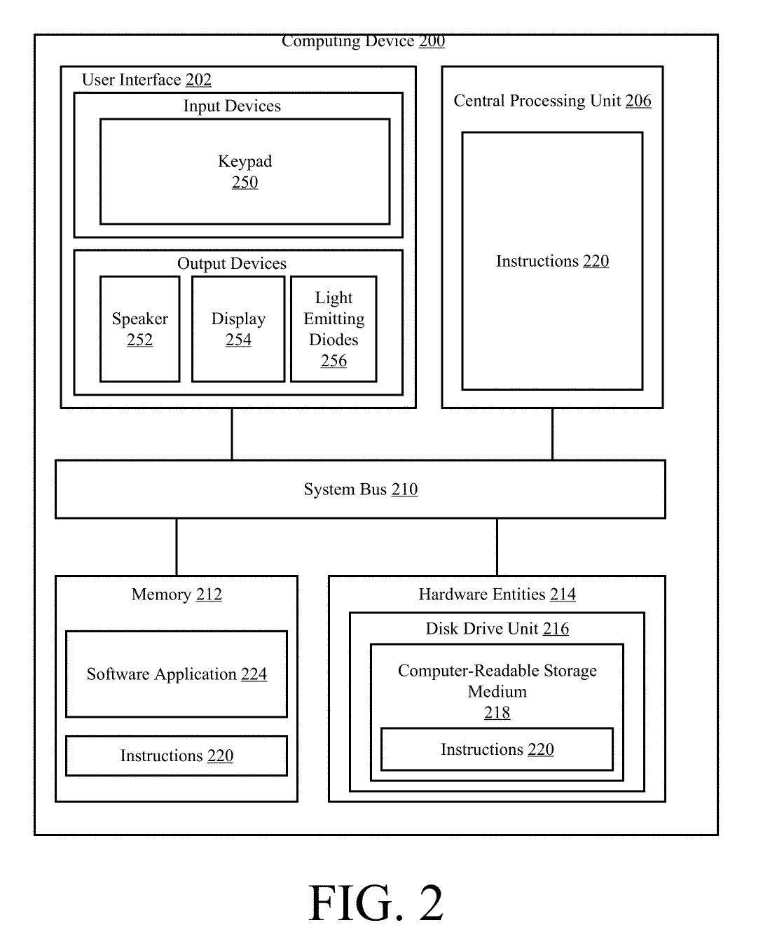

Referring now to FIG. 2, there is provided a detailed block diagram of an exemplary architecture for a computing device 200, where the client machine 102 and server 106 illustrated in FIG. 1 can be deployed as and/or executed on any embodiment of the computing device 200. As such, the following discussion of computing device 200 is sufficient for understanding client machine(s) 102 and/or server(s) 106 of FIG. 1.

Computing device 200 may include more or less components than those shown in FIG. 2. However, the components shown are sufficient to disclose an illustrative embodiment implementing the present solution. The hardware architecture of FIG. 2 represents one embodiment of a representative computing device configured to facilitate storage and/or transmission of sensitive information in a cloud computing environment. As such, the computing device 200 of FIG. 2 implements at least a portion of a method for transmission of data to a client device using an energy efficient remote access protocol, as discussed below.

Some or all the components of the computing device 200 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 2, the computing device 200 comprises a user interface 202, a Central Processing Unit (“CPU”) 206, a system bus 210, a memory 212 connected to and accessible by other portions of computing device 200 through system bus 210, and hardware entities 214 connected to system bus 210. The user interface can include input devices (e.g., a keypad 250) and output devices (e.g., speaker 252, a display 254, and/or light emitting diodes 256), which facilitate user-software interactions for controlling operations of the computing device 200.

At least some of the hardware entities 214 perform actions involving access to and use of memory 212, which can be a RAM, a disk driver and/or a Compact Disc Read Only Memory (“CD-ROM”). Hardware entities 214 can include a disk drive unit 216 comprising a computer-readable storage medium 218 on which is stored one or more sets of instructions 220 (e.g., software code) configured to implement one or more of the methodologies, procedures, or functions described herein. The instructions 220 can also reside, completely or at least partially, within the memory 212 and/or within the CPU 206 during execution thereof by the computing device 200. The memory 212 and the CPU 206 also can constitute machine-readable media. The term “machine-readable media”, as used here, refers to a single medium or multiple media (e.g., a centralized or distributed database, and/or associated caches and servers) that store the one or more sets of instructions 220. The term “machine-readable media”, as used here, also refers to any medium that is capable of storing, encoding or carrying a set of instructions 222 for execution by the computing device 200 and that cause the computing device 200 to perform any one or more of the methodologies, as described herein.

In certain embodiments, computing device 200 may include a power supply unit (not shown) such as, for example, a battery or other power source.

In some scenarios, the hardware entities 214 include an electronic circuit (e.g., a processor) programmed for facilitating method for transmission of data to a client device using an energy efficient remote access protocol. In this regard, it should be understood that the electronic circuit can access and run a software application 224 installed on the computing device 200. The functions of the software application 224 will become apparent as the discussion progresses.

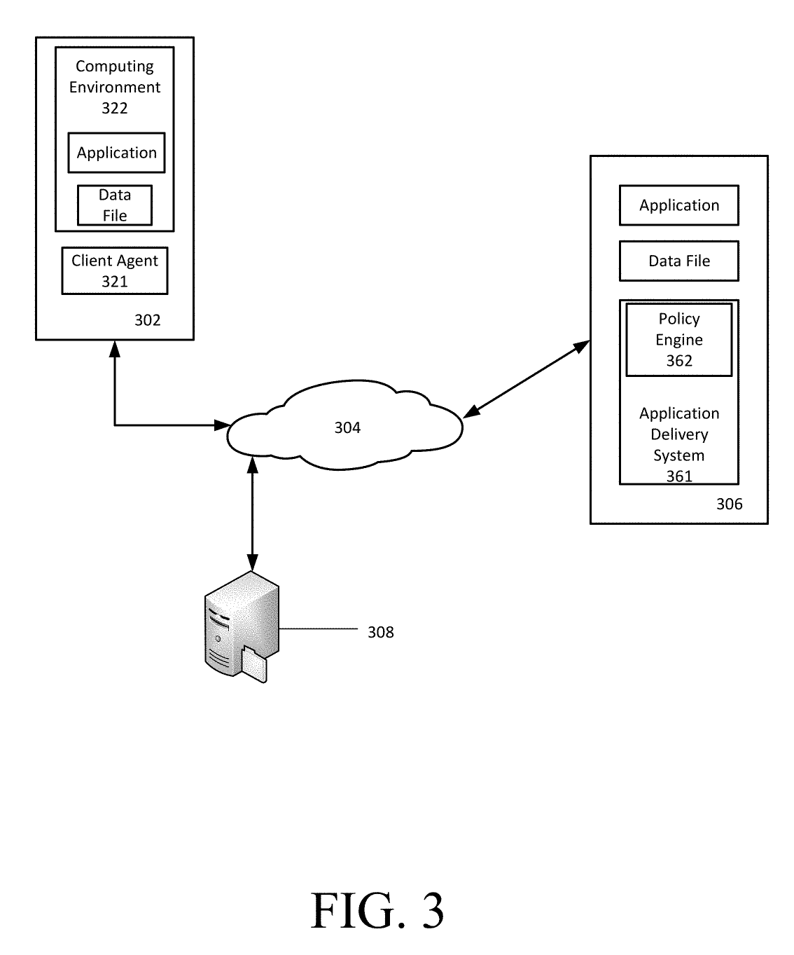

Referring now to FIG. 3, an illustrative computing system that may be used to implement one or more illustrative aspects described herein is shown. System 300 may include more or less components than those shown in FIG. 3. However, the components shown are sufficient to disclose an illustrative embodiment implementing the present solution. Some or all the components of the computing system 300 can be implemented as hardware, software and/or a combination of hardware and software, arranged to and/or programmed to perform one or more of the methodologies, procedures, or functions described herein.

As shown in FIG. 3, the system 300 comprises a client device 302 (e.g., a mobile device) and a sever 306 in communication via a network 304. The system 300 further comprises a data store 308. It will be understood to those skilled in the art that client device 302 and server 306 may be any client device or server of a cloud computing environment, as discussed above with respect to FIG. 1.

In an embodiment, the client device 302 may include a client agent 321, and a computing environment 322. The computing environment 322 may execute or operate an application that accesses, processes or uses a data file. The computing environment 322, application and/or data file may be delivered to the client device 302 via the server 306.

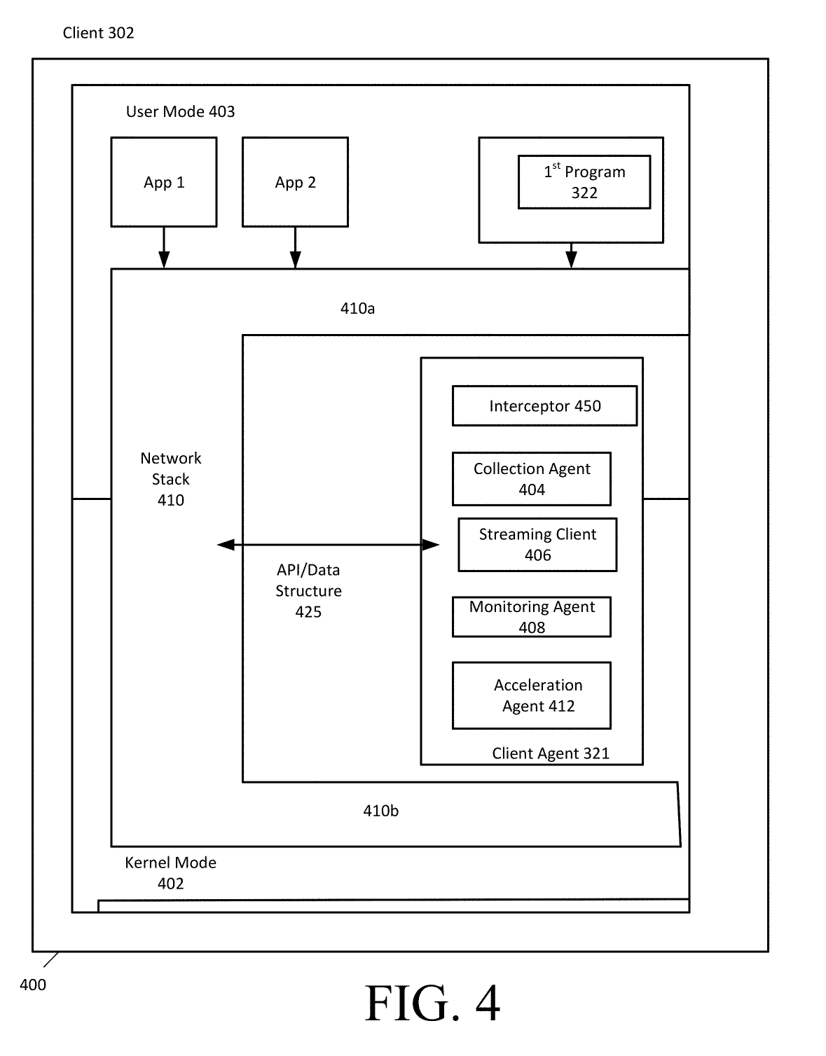

FIG. 4 illustrates a block diagram depicting an embodiment of the client agent 321. In brief overview, the client device 302 operates on computing device 400 having an operating system with a kernel mode 402 and a user mode 403, and a network stack 410 with one or more layers 410a-410b. The client device 302 may have installed and/or execute one or more applications. In some embodiments, one or more applications may communicate via the network stack 410 to a network. One of the applications, such as a web browser, may also include a first program 422. For example, the first program 422 may be used in some embodiments to install and/or execute the client agent 321, or any portion thereof. The client agent 321 includes an interception mechanism, or interceptor 450, for intercepting network communications from the network stack 410 from the one or more applications.

The network stack 410 of the client device 302 may comprise any type and form of software, or hardware, or any combinations thereof, for providing connectivity to and communications with a network. In one embodiment, the network stack 410 comprises a software implementation for a network protocol suite. The network stack 410 may comprise one or more network layers, such as any networks layers of the Open Systems Interconnection (OSI) communications model as those skilled in the art recognize and appreciate. As such, the network stack 410 may comprise any type and form of protocols for any of the following layers of the OSI model: 1) physical link layer, 2) data link layer, 3) network layer, 4) transport layer, 5) session layer, 6) presentation layer, and 7) application layer. In one embodiment, the network stack 410 may comprise a transport control protocol (TCP) over the network layer protocol of the internet protocol (IP), generally referred to as TCP/IP. In some embodiments, the TCP/IP protocol may be carried over the Ethernet protocol, which may comprise any of the family of IEEE wide-area-network (WAN) or local-area-network (LAN) protocols, such as those protocols covered by the IEEE 802.4. In some embodiments, the network stack 410 comprises any type and form of a wireless protocol, such as IEEE 802.11 and/or mobile internet protocol.

In view of a TCP/IP based network, any TCP/IP based protocol may be used, including Messaging Application Programming Interface (MAPI) (email), File Transfer Protocol (FTP), HyperText Transfer Protocol (HTTP), Common Internet File System (CIFS) protocol (file transfer), Independent Computing Architecture (ICA) protocol, Remote Desktop Protocol (RDP), Wireless Application Protocol (WAP), Mobile IP protocol, and Voice Over IP (VoIP) protocol. In another embodiment, the network stack 410 comprises any type and form of transport control protocol, such as a modified transport control protocol, for example a Transaction TCP (T/TCP), TCP with selection acknowledgements (TCP-SACK), TCP with large windows (TCP-LW), a congestion prediction protocol such as the TCP-Vegas protocol, and a TCP spoofing protocol. In other embodiments, any type and form of user datagram protocol (UDP), such as UDP over IP, may be used by the network stack 410, such as for voice communications or real-time data communications.

Furthermore, the network stack 410 may include one or more network drivers supporting the one or more layers, such as a TCP driver or a network layer driver. The network drivers may be included as part of the operating system of the computing device 400 or as part of any network interface cards or other network access components of the computing device 400. In some embodiments, any of the network drivers of the network stack 410 may be customized, modified or adapted to provide a custom or modified portion of the network stack 410 in support of any of the techniques described herein. In other embodiments, the acceleration agent 412 is designed and constructed to operate with or work in conjunction with the network stack 410 installed or otherwise provided by the operating system of the client device 302.

The network stack 410 comprises any type and form of interfaces for receiving, obtaining, providing or otherwise accessing any information and data related to network communications of the client device 302. In one embodiment, an interface to the network stack 410 comprises an application programming interface (API). The interface may also comprise any function call, hooking or filtering mechanism, event or call back mechanism, or any type of interfacing technique. The network stack 410 via the interface may receive or provide any type and form of data structure, such as an object, related to functionality or operation of the network stack 410. For example, the data structure may comprise information and data related to a network packet or one or more network packets. In some embodiments, the data structure comprises a portion of the network packet processed at a protocol layer of the network stack 410, such as a network packet of the transport layer. In some embodiments, the data structure 425 comprises a kernel-level data structure, while in other embodiments, the data structure 425 comprises a user-mode data structure. A kernel-level data structure may comprise a data structure obtained or related to a portion of the network stack 410 operating in kernel-mode 402, or a network driver or other software running in kernel-mode 402, or any data structure obtained or received by a service, process, task, thread or other executable instructions running or operating in kernel-mode of the operating system.

Additionally, some portions of the network stack 410 may execute or operate in kernel-mode 402, for example, the data link or network layer, while other portions execute or operate in user-mode 403, such as an application layer of the network stack 410. For example, a first portion 410a of the network stack may provide user-mode access to the network stack 410 to an application while a second portion 410b of the network stack 410 provides access to a network. In some embodiments, a first portion 410a of the network stack may comprise one or more upper layers of the network stack 410, such as any of layers 5-7. In other embodiments, a second portion 410b of the network stack 410 comprises one or more lower layers, such as any of layers 1-4. Each of the first portion 410a and second portion 410b of the network stack 410 may comprise any portion of the network stack 410, at any one or more network layers, in user-mode 403, kernel-mode, 402, or combinations thereof, or at any portion of a network layer or interface point to a network layer or any portion of or interface point to the user-mode 403 and kernel-mode 402.

The client agent 321 and/or network stack 410 may be designed and constructed to implement a remote access protocol (such as, HDX). In an embodiment, a remote access protocol is a set of capabilities that are configured to deliver a high-definition user experience of virtual desktops and applications to a client device in a cloud computing environment. For example, HDX implementation is designed and constructed to perform intelligent redirection, adaptive compression and data de-duplication which may work in concert to improve the user experience, decrease bandwidth consumption and increase the scalability of the hosting server. In some implementations, HDX technologies may be built on or using the remote access protocol. In some embodiments, HDX technologies are built on top of a remote access protocol, such as the Citrix® ICA® remoting protocol, which is some implementations is based on TCP/IP and/or RTP/UDP and is designed to traverse difficult network topologies such as mobile networks with high variability and low-bandwidth WANs with high latency characteristics.

The client agent 321 and/or network stack 410 may include or implement an ICA driver configured to implement and includes the functionality to support and manage connections/sessions via a remote access protocol, such as ICA protocol, including establishing and managing virtual channels, described in further detail below. The client agent 321 may be designed and constructed to be a receiver for remote access protocol, such as ICA and/or HDX protocols and to receive, process and interact with displayed outputted from an application executing and hosted on a host server.

The remote protocol session (sometimes also referred to as a connection) over the transport layer connection may comprise one or more channels defined by a remoting protocol. The remoting protocol may define one or more channels, referred to as virtual channels, in the connection for delivering and/or enabling one or more features of the resources to the client 302. In some embodiments, each of the one or more channels may be configured to deliver and/or enable at least one feature or functionality of the resource to the client. The resource may support one or more features or functionalities, and may deliver any one or more of these to the client via the connection according to the remoting protocol. These features or functionalities may include or enable a clipboard feature (e.g., to cut, copy and/or paste data), touchscreen feature, keyboard feature (e.g., to enter text via the client using a physical or touchscreen keyboard), download or save feature (e.g. download or save a file to the client from a remote desktop), print feature (print a document from a remote desktop from a local printer connected to the client), modification feature (e.g., modify a file accessible via a remote application), or the like.

In some embodiments, remote access protocol provides adaptive redirection functionality. Remote access protocol may be designed and constructed to examine screen activity, application commands, such as via the remote access protocol and endpoint device, network and server capabilities to determine, in real-time how and where to render an application or desktop activity.

Redirection activity can occur at the local client or device. Client redirection offloads tasks from the server and places them on the client. With device and peripheral redirection, webcams, printers and scanners can be terminated locally to allow users to interact with these devices at native USB speeds.

In an embodiment, the remoting protocol is further configured to provide battery redirection in a remote desktop session. Specifically, the remoting protocol may redirect, to a remote server, the battery of a client device to create a virtual battery such that the battery is accessible from the server as if it were connected locally to server. Battery of a client device may be accessed from a server when the client device is connected to the server through a user session or remote session running on the server. For example, the battery may be accessible from a remote desktop running on the server (i.e., virtual desktop environment). When a battery is redirected to a server from a client device, the server may create a device stack (using now or hereafter known methods) for that battery to manage interactions with the redirected battery. As such, a redirected battery becomes a local battery to the server and can be accessed by all the remote sessions connected to that server. In an embodiment, creation of a virtual battery in a remote session allows for information corresponding to the battery to be redirected to the server, and the server may initiate actions directly based on the redirected battery information allowing for a seamless management of client device power by the server during the remote session. Examples of such information may include, without limitation, battery charge status, battery profiles associated with the client device OS (e.g., actions to be performed for conservation of battery life based on the battery charge status), event notifications (e.g., low battery), information corresponding to whether the battery is connected to an external power source, or the like.

In some embodiments, remote access protocol provides adaptive compression. Remote access protocol may be designed and constructed to set and/or change the codecs that are used via the remote access protocol. Remote access protocol may adapt and change the codes used based on operating conditions of the client device (such as, without limitation, battery status of the client device). Remote access protocol may adapt or change the code used responsive to and during different network conditions. In some embodiments, remote access protocol is designed and constructed to determine improved or intelligent utilization of CPU and/or GPU resources, such as for compression.

In some embodiments, remote access protocol provides de-duplication of network traffic. Remote access protocol may be designed and constructed to de-duplicate network traffic through multicasting and caching techniques. Remote access protocol may provide, support or perform multicasting of multimedia streams, where delivery of a single transmission from the source to many users creates one-to-many communications. In some embodiments, remote access protocol caching de-duplicates commonly accessed data including bitmap graphics, files, print jobs and streamed media.

The client agent 321 also includes an acceleration agent 412, a streaming client 406, a collection agent 404, and/or a monitoring agent 408. In one embodiment, the client agent 321 comprises an Independent Computing Architecture (ICA) client, or any portion thereof, developed by Citrix Systems, Inc. of Fort Lauderdale, Fla., and is also referred to as an ICA client. In some embodiments, the client 302 comprises an application streaming client 406 for streaming an application from a server 306 to a client device 302. In some embodiments, the client agent 321 comprises an acceleration agent 412 for accelerating communications between client device 302 and server 306. In another embodiment, the client agent 321 includes a collection agent 404 for performing end-point detection/scanning and collecting end-point information for the server 306.

In some embodiments, the acceleration agent 412 comprises a client-side acceleration program for performing one or more acceleration techniques to accelerate, enhance or otherwise improve a client's communications (e.g., to enhance battery life of the client device 302) with and/or access to a server 306, such as accessing an application provided by a server 306. The logic, functions, and/or operations of the executable instructions of the acceleration agent 412 may perform one or more of the following acceleration techniques: 1) multi-protocol compression, 2) transport control protocol pooling, 3) transport control protocol multiplexing, 4) transport control protocol buffering, and 5) caching via a cache manager. Additionally, the acceleration agent 412 may perform encryption and/or decryption of any communications received and/or transmitted by the client device 302. In some embodiments, the acceleration agent 412 performs one or more of the acceleration techniques in an integrated manner or fashion. Additionally, the acceleration agent 412 can perform compression on any of the protocols, or multiple-protocols, carried as a payload of a network packet of the transport layer protocol. The streaming client 406 comprises an application, program, process, service, task or executable instructions for receiving and executing a streamed application from a server 306. A server 306 may stream one or more application data files to the streaming client 406 for playing, executing or otherwise causing to be executed the application on the client device 302. In some embodiments, the server 306 transmits a set of compressed or packaged application data files to the streaming client 406. In some embodiments, the plurality of application files are compressed and stored on a file server within an archive file such as a CAB, ZIP, SIT, TAR, JAR or other archive. In one embodiment, the server 306 decompresses, unpackages or unarchives the application files and transmits the files to the client device 302. In another embodiment, the client device 302 decompresses, unpackages or unarchives the application files. The streaming client 406 dynamically installs the application, or portion thereof, and executes the application. In one embodiment, the streaming client 406 may be an executable program. In some embodiments, the streaming client 406 may be able to launch another executable program.

The collection agent 404 comprises an application, program, process, service, task or executable instructions for identifying, obtaining and/or collecting information about the client device 302. In some embodiments, an appliance or server transmits the collection agent 404 to the client device 302 or client agent 321. The collection agent 404 may be configured according to one or more policies of an appliance or server. In other embodiments, the collection agent 404 transmits collected information on the client device 302, to the sever 306, to an appliance. In one embodiment, the sever 306 may use the collected information to determine and provide access, authentication and authorization control of the client's connection to a network 104.

In one embodiment, the collection agent 404 comprises an end-point detection and scanning mechanism, which identifies and determines one or more attributes or characteristics of the client device 302. For example, the collection agent 404 may identify and determine any one or more of the following client-side attributes: 1) the operating system and/or a version of an operating system, 2) a service pack of the operating system, 3) a running service, 4) a running process, and 5) a file. The server 306 may have one or more policies based on any one or more of the attributes or characteristics of the client or client-side attributes.

In an embodiment, the collection agent 404 may include an end-point battery profile manager that identifies and determines one or more attributes or characteristics of a battery or other power source included in the client device 302. For example, the collection agent 404 may identify and determine any one or more of the following battery or power source attributes: 1) current charge status of the battery; 2) battery life; 3) battery type and properties; 4) whether or not the client device is connected to external power; and/or other characteristics in connection with determining a power consumption rate. In an embodiment, the collection agent 404 may receive the battery or power source attributes from an operating system of the client device periodically, continuously, and/or upon occurrence of a triggering event (e.g., certain battery percentage levels, certain time to complete battery discharge, or the like). Alternatively and/or additionally, if the battery is redirected into the remote session, the collection agent 404 may receive the battery or power source attributes from the virtual battery created during the remote session.

In some embodiments, the client agent 321 also includes a monitoring agent 408 configured to perform, without limitation, monitoring, measurement and/or management software and/or hardware, including data collection, aggregation, analysis, management and reporting. In an embodiment, the monitoring agent 408 may monitor and measure performance of any portion of the client agent 321 and/or any resource of the client device 302 (such as memory, CPU, and disk). The monitoring agent 408 may be any type and form of script, such as Visual Basic or Java script. For example, in some embodiments, the monitoring agent 408 monitors and measures performance of the acceleration agent 412. In another embodiment, the monitoring agent 408 monitors and measures performance of the streaming client 406. In other embodiments, the monitoring agent 408 monitors and measures performance of the collection agent 404.

The monitoring agent 408 may also monitor and measure performance of any application of the client device 302. In one embodiment, the monitoring agent 408 monitors and measures performance of a browser on the client device 302. In some embodiments, the monitoring agent 408 monitors and measures performance of any application delivered via the client agent 321. In other embodiments, the monitoring agent 408 measures and monitors end user response times for an application, such as web-based or HTTP response times. The monitoring agent 408 may monitor and measure performance of an ICA or RDP client. In another embodiment, the monitoring agent 408 measures and monitors metrics for a user session or application session. In some embodiments, monitoring agent 408 measures and monitors an ICA or RDP session.

In an embodiment, the monitoring agent 408 may also monitor and measure the performance of an application of the client device 302 and/or a portion of the client agent 321 as a function of power requirements and/or battery discharge. In an embodiment, the monitoring agent 408 may also monitor and measure the performance of an application of the client device 302 and/or a portion of the client agent 321 as a function of power requirements and/or battery discharge such as total battery usage, battery usage per user session and/or battery usage per process. For example, the monitoring agent 408 may monitor the rate of power consumption by a client device while executing an application (e.g., application for streaming video and/or audio, an application for facilitating real-time-data communications, or the like) during a local and/or a remote session. In an embodiment, the monitoring agent 408 may include and/or may have access to historical data corresponding to power requirements for executing various applications and/or processes on a client device via, for example, a remote access protocol.

In some embodiments and still referring to FIG. 4, a first program 422 may be used to install and/or execute the client agent 321, or portion thereof automatically, silently, transparently, or otherwise. In one embodiment, the first program 422 comprises a plugin component, such an ActiveX control or Java control or script that is loaded into and executed by an application. For example, the first program comprises an ActiveX control loaded and run by a web browser application, such as in the memory space or context of the application. In another embodiment, the first program 422 comprises a set of executable instructions loaded into and run by the application, such as a browser. In one embodiment, the first program 422 comprises a designed and constructed program to install the client agent 321. In some embodiments, the first program 422 obtains, downloads, or receives the client agent 321 via the network from another computing device. In another embodiment, the first program 422 is an installer program or a plug and play manager for installing programs, such as network drivers, on the operating system of the client device 302.

It will be understood to those skilled in the art that one or more components of the client agent 321 may executes transparently to any application and/or user of a device. In some embodiments, the monitoring agent is installed and operated unobtrusively to the application or client. In yet another embodiment, the monitoring agent is installed and operated without any instrumentation for the application or device.

Referring back to FIG. 3, in an embodiment, the server 306 may include an application delivery system 361 for delivering a computing environment or an application and/or data file to the client device 302 during a remote session. In brief overview, a client machine in communication with a server may reside in a remote office of a company, e.g., a branch office, and the server may reside at a corporate data center. The client machine may include a client agent 321 and a computing environment 322, where the computing environment may execute or operate an application that accesses, processes or uses a data file. In some embodiments, the application delivery system 361 provides application delivery techniques to deliver a computing environment to a desktop of a user, remote or otherwise, based on a plurality of execution methods and based on any authentication and authorization policies applied via a policy engine 362. With these techniques, a remote user may obtain a computing environment and access to server stored applications and data files from any network connected device (i.e., establish a remote session). In some embodiments, the application delivery system 361 comprises any portion of the Citrix Workspace Suite™ by Citrix Systems, Inc., such as XenApp® or XenDesktop® and/or any of the Microsoft® Windows Terminal Services manufactured by the Microsoft Corporation. In one embodiment, the application delivery system 361 may deliver one or more applications to client devices or users via a remote access protocol or otherwise via remote-based or server-based computing. In another embodiment, the application delivery system 361 may deliver one or more applications to clients or users via steaming of the application.

In one embodiment, the application delivery system 361 includes a policy engine 362 for controlling and managing the access to application, the selection of application execution methods, and the delivery of applications. In some embodiments, the policy engine 362 determines the one or more applications a user or client device 302 may access. In another embodiment, the policy engine 362 determines how the application should be delivered to the user or client 302, e.g., the method of execution. In some embodiments, the application delivery system 361 provides a plurality of delivery techniques from which to select a method of application execution, such as a server-based computing, streaming or delivering the application locally to the client device for local execution.

In an embodiment, the policy engine 362 may control and manage the access to applications, the selection of application execution methods, and the delivery of applications to the client device 302 based on one or more battery or power source attributes of the client device 302 (i.e., battery profile). The policy engine 362 may receive and/or access (e.g., from a data store 108, discussed below) a rule set for performing said controlling and managing of the applications, where the rule set associates one or more actions corresponding to the battery profile of the client device. In an embodiment, such actions are configured to adjust parameters of a remote access protocol for causing energy aware transmission of data from the server to the client device.

In an embodiment, the policy engine 362 may receive the one or more battery or power source attributes of the client device 302 from, for example, the collection device 404 an operating system of the client device, and/or a virtual battery via redirection. The policy engine 362 may also receive performance attributes of one or more applications as a function of power requirement and/or battery discharge on the client device 302 from the monitoring agent 408.

Referring back to FIG. 3, the system 300 also includes a data store 108. In an embodiment, data store 108 may be configured to store a rules set for control and management of applications (access, selection, and delivery) based on a battery profile of the client device. The battery profile may include one or more power related attributes of the client device such as without limitation, current charge status or percentage of the battery (or batteries), a rate of power consumption by the processes executing on the client device (such as a remote session), whether or not the client device is connected to an external power source (e.g., for recharging of one or more batteries), properties or characteristics of the batteries of the client device, time remaining till complete discharge, and/or other characteristics in connection with the power source of the client device 302. In an embodiment, the rule set may include one or more look up tables that associate the battery profile of the client device with one or more actions configured to adjust one or more properties of a remote session. For example, the actions may be configured to cause an energy efficient transmission of data to the client device using a remote access protocol.

In an embodiment, different look up tables may be created for different types of client devices (e.g., smartphones, laptops, tablets, etc. may each have a corresponding look up table), for different client device models, for different manufactures, or the like. In an embodiment, a user (e.g., network administrators, a device manufacturers, or the like) may create the look up tables. Alternatively and/or additionally, the system may automatically create the look up tables automatically by analyzing power consumption data as a function of different processes and/or applications running on a client device.

Example rules for control and management of applications based on the current battery or power source attributes of the client device include, without limitation, may associate one or more of the following actions (to be performed on, for example, a remote access protocol) with different battery profiles:

A) Disabling one or more high bandwidth consumption virtual channels, such as, without limitation drive mapping.

B) Adjusting the number of frames transmitted per second by the graphics virtual channel (for example, the system may reduce the number of frames transmitted per second to reduce consumption of power during processing, receipt, etc.).

C) Selecting audio and/or video codec types that require less power for transmission and rendering on the client device (for example, the system may perform compression of data to reduce bandwidth, adjust the compression ratio, and/or not perform compression to reduce processing at the client device and hence reduce the power consumption).

D) Adjusting the image quality to optimize data processing at the client device while maximizing the battery life (for example, the system may display lower quality of images, such as lower resolution images, to reduce power consumption at the client device and/or display low quality images only when rigorous image quality is not required).

E) Providing prompts to a user of the client device to select applications whose execution consumes less power (for example, the system may enable transmission of audio without video streaming while running a media application).

F) Transmitting and rendering only certain regions of a desktop on the client device (for example, the system may enable transmitting and rendering only the reading pane of an email application display).

G) Caching stable regions of a desktop locally to avoid transmission and rendering of such regions (for example, the system may cache regions of applications displayed on the desktop that have been stable over a threshold period of time to reduce power consumption associated with transmission, receipt, and rendering of images associated with such stable regions).

In an embodiment, the above actions may be implemented dynamically in real-time, based on, for example, the battery charge percentage, whether or not the battery is attached to a charging source, rate of power consumption by the client device, or the like. For example, in an embodiment, the look up tables may associate different battery profiles with one or more of the above actions, and define the parameters for performing the corresponding actions. For example, a look up table may include a rule that if a client device battery is at a normal battery profile (e.g., >80% of remaining battery power), the remote access protocol may transmit data without implementing any actions for power aware transmission of data; if a client device is at a low battery profile (e.g., 30-40% of remaining battery power and 10-15 mins to discharge), the remote access protocol must transmit data at X frames per second and without the use of a high bandwidth virtual channel; and if a client device battery is at critically low battery profile (e.g., 10-25% of remaining battery power and less than 5 mins to discharge), the remote access protocol must transmit data at Y frames per second without the use of a high bandwidth virtual channel, and disable video streaming, and render only critical parts of a desktop. In another embodiment, the rule set may include a different set of actions for each battery profile if the battery is connected to an external power source. For example, when the client device is connected to an external power source, the rule set may require transmission of data to achieve highest quality. In another example, when the client device is connected to an external power source, the rule set may require that no action be performed to implement a power aware transmission of data.

Alternatively and/or additionally, the battery profile may also include the rate of power consumption and/or time to a threshold discharge percentage at any time with one or more of the above rules, and define the parameters for performing the corresponding actions.

The rule set may also require requesting user input and/or considering user preferences in determining the appropriate data transmission action. For example, a user may specify one or more actions may not be performed during execution of one or more applications in a remote session. Examples of such rules may include, without limitation, not executing one or more power consumption actions during a VoIP call, while playing a media stream, during certain business hours, during remote session associated with certain user, or the like. Alternatively and/or additionally, the client device may prompt a user to confirm the selected actions before executing them, thus providing the user a chance to override or modify the selection.

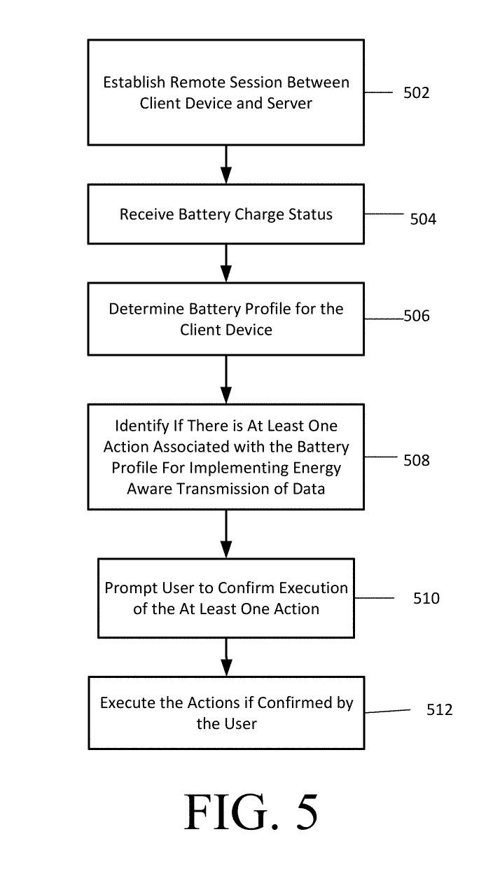

Referring now to FIG. 5, an example method 500 for energy efficient transmission of data in a remote access protocol in a cloud computing environment is illustrated. An example cloud computing environment 100 is illustrated in FIG. 1. In one or more embodiments, the process 500 illustrated in FIG. 5 and/or one or more steps thereof may be performed by a computing device (e.g., any device of FIG. 1 or FIG. 3). In other embodiments, the process illustrated in FIG. 5 and/or one or more steps thereof may be embodied in computer-executable instructions that are stored in a computer-readable medium, such as a non-transitory computer-readable memory. While the method 500 is described for the sake of convenience and not with an intent of limiting the disclosure as comprising a series and/or a number of steps, it is to be understood that the process does not need to be performed as a series of steps and/or the steps do not need to be performed in the order shown and described with respect to FIG. 5, but the process may be integrated and/or one or more steps may be performed together, or the steps may be performed in the order disclosed or in an alternate order.

The method may start at 502 when a remote session is established between a client device and a server for providing the client device access to one or more applications or resources on the server, and that requires transmission of data to the client device. Data may be transmitted, for example, a via a remote access protocol such as HDX.

At 504, the system may receive a battery charge status corresponding to one or more batteries of the client device. The battery charge status may include, for example, the percentage of remaining battery life. The system may receive the battery charge status from an operating system of the client device, an application delivery system (e.g., collection agent discussed above), a virtual battery during redirection, or the like. In an embodiment, the system may receive the battery charge status continuously, at periodic intervals, and/or upon occurrence of a triggering event (e.g., certain battery charge percentage, certain rate of power consumption, certain time to complete discharge, or the like).

At 506, the system may determine an overall battery profile for the client device that includes characteristics or attributes of the power status for the client device. It should be noted that the battery profile may correspond to a single battery of the client device and/or the overall power source for the client device. In an embodiment, example characteristics and/or attributes may include the battery charge status, whether or not the battery is connected to an external power source, rate of power consumption for the client device, time remaining until complete discharge, or the like.

In an embodiment, the system may determine the rate of power consumption of the client device that is attributable to the remote session. For example, the system may determine the rate of power consumption based on the characteristics of the client device as well as those of one or more active applications and/or processes being executed by the client device as part of the remote session. Such characteristics may include, without limitation, network connection bandwidth and type, radio signal strength required for executing an application, processing power requirement for the application, user requested quality level, size of data being transmitted, data transmission rate, processing costs, refresh rates associated an output screen, or the like. In an embodiment, the system may monitor and measure the performance of one or more application as a function of power requirements and/or battery discharge such as total battery usage, battery usage per user session and/or battery usage per process. The system may also use historical data corresponding to power requirements for executing applications and/or processes on the client device to determine the rate of power consumption.

In an embodiment, the system may determine the time remaining to discharge the battery (in the absence of external power) based on the rate of power consumption and the battery charge status.

At 508, the system may use the battery profile to determine if there is at least one action associated with the battery profile that can be executed for implementing an energy aware transmission of data during the remote session (as discussed above) and using a remote access protocol. In an embodiment, if the battery profile for the client device does not indicate a need for power aware transmission of data, there may not be any actions associated with the battery profile for implementing an energy aware transmission of data. As discussed above, the system may use a rule set to associate the battery profile with one or more actions.

At 510, the system may prompt a user to confirm execution of the identified actions, thus providing the user a chance to override and/or modify the selection of one or more actions. Alternatively and/or additionally, the system may execute the action without prompting the user to confirm the execution but may allow a user to override the execution at a later time.

At 512, if the user confirms execution of one or more of the identified actions, the system may execute those actions to implement the energy aware transmission of data during the remote session. The system does not execute the actions that are not confirmed by the user.

It should be understood that the systems described above may provide multiple ones of any or each of those components and these components may be provided on either a standalone machine or, in some embodiments, on multiple machines in a distributed system. The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either software application or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a field programmable gate array (FPGA), etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

What is claimed is:

1. A method for energy aware transmission of data to a client device in a cloud environment, the method comprising, by a processor:
establishing a remote session between the client device and a server;
receiving a battery status corresponding to the client device;
determining, for the client device, a battery profile associated with the received battery status;
accessing a rule set to determine if there is at least one action associated with the battery profile, wherein the at least one action corresponds to transmission of data from the server to the client device; and
if there is at least one action associated with the battery profile, executing the at least one action.

2. The method of claim 1, wherein receiving the battery status corresponding to the client device comprises receiving one or more of the following: battery power level of one or more batteries of the client device, or an indication corresponding to whether or not the client device is connected to an external power source.

3. The method of claim 1, wherein determining the battery profile associated with the received battery status comprises determining a rate of power consumption by the client device, wherein the rate of power consumption is attributable to the remote session.

4. The method of claim 3, wherein determining the battery profile associated with the received battery status further comprises determining a time remaining until total discharge of client device power reserves based on the rate of power consumption and the battery status.

5. The method of claim 3, wherein determining the rate of power consumption comprises monitoring one or more characteristics of one or more active applications corresponding to the remote session, wherein the one or more characteristics are selected from the following: network connection bandwidth, network connection type, radio signal strength required for executing an application, processing power requirement for am application, user requested quality level, size of data being transmitted from the server to the client, data transmission rate, processing costs, or refresh rates associated an output screen.

6. The method of claim 1, wherein the at least one action is selected from one or more of the following:
disabling one or more high bandwidth consumption virtual channels;
adjusting the number of frames transmitted per second;
selecting audio and/or video codec types that require less power for transmission and rendering on the client device;
adjusting the image quality to optimize data processing at the client device while maximizing the battery life;
providing prompts to a user of the client device to select applications whose execution consumes less power;
transmitting and rendering only certain regions of a desktop on the client device; or
caching stable regions of a desktop locally to avoid transmission and rendering of such regions.

7. The method of claim 1, wherein receiving the battery status corresponding to the client device comprises receiving the battery status from one or more of the following: an operating system of the client device, a redirected virtual battery, or from a client agent corresponding to the remote session.

8. The method of claim 1, wherein receiving the battery status corresponding to the client device comprises receiving the battery status continuously, periodically, or upon occurrence of a triggering event.

9. The method of claim 8, wherein the triggering event comprises one or more of the following: a threshold battery charge percentage, a threshold rate of power consumption, or a threshold time to complete discharge of a battery.

10. The method of claim 1, wherein the rule set comprises:
one or more look up tables; and
each look up table associates each of a plurality of battery profiles with one or more actions corresponding to transmission of data from the server to the client device.

11. The method of claim 1, further comprising: prompting a user to confirm execution of the at least one action.

12. A system for energy aware transmission of data to a client device in a cloud environment, the system comprising:
a processor; and
a non-transitory computer-readable storage medium comprising programming instructions that are configured to cause the processor to:
establish a remote session between the client device and a server;
receive a battery status corresponding to the client device;
determine, for the client device, a battery profile associated with the received battery status;
access a rule set to determine if there is at least one action associated with the battery profile, wherein the at least one action corresponds to transmission of data from the server to the client device; and
if there is at least one action associated with the battery profile, execute the at least one action.

13. The system of claim 12, wherein the programming instruction that cause the processor to receive the battery status corresponding to the client device comprise instructions to receive one or more of the following: battery power level of one or more batteries of the client device, or an indication corresponding to whether or not the client device is connected to an external power source.

14. The system of claim 12, wherein the programming instruction that cause the processor to determine the battery profile associated with the received battery status comprise instructions to determine a rate of power consumption by the client device, wherein the rate of power consumption is attributable to the remote session.

15. The system of claim 14, wherein the programming instruction that cause the processor to determine the battery profile associated with the received battery status further comprise instructions to determine a time remaining until total discharge of client device power reserves based on the rate of power consumption and the battery status.

16. The system of claim 14, wherein the programming instruction that cause the processor to determine the rate of power consumption comprise instructions to monitor one or more characteristics of one or more active applications corresponding to the remote session, wherein the one or more characteristics are selected from the following: network connection bandwidth, network connection type, radio signal strength required for executing an application, processing power requirement for am application, user requested quality level, size of data being transmitted from the server to the client, data transmission rate, processing costs, or refresh rates associated an output screen.

17. The system of claim 12, wherein the at least one action is selected from one or more of the following:
disabling one or more high bandwidth consumption virtual channels;
adjusting the number of frames transmitted per second;
selecting audio and/or video codec types that require less power for transmission and rendering on the client device;
adjusting the image quality to optimize data processing at the client device while maximizing the battery life;
providing prompts to a user of the client device to select applications whose execution consumes less power;
transmitting and rendering only certain regions of a desktop on the client device; or
caching stable regions of a desktop locally to avoid transmission and rendering of such regions.

18. The system of claim 12, wherein receiving the battery status corresponding to the client device comprises receiving the battery status from one or more of the following: an operating system of the client device, a redirected virtual battery, or from a client agent corresponding to the remote session.

19. The system of claim 12, wherein the programming instruction that cause the processor to receive the battery status corresponding to the client device comprise instructions to receive the battery status continuously, periodically, or upon occurrence of a triggering event.

20. The system of claim 19, wherein the triggering event comprises one or more of the following: a threshold battery charge percentage, a threshold rate of power consumption, or a threshold time to complete discharge of a battery.

21. The system of claim 12, wherein the rule set comprises:
one or more look up tables; and
each look up table associates each of a plurality of battery profiles with one or more actions corresponding to transmission of data from the server to the client device.

22. The system of claim 12, further comprising programming instructions that cause the processor to prompt a user to confirm execution of the at least one action.
